(19) United States
(12) Patent Application Publication
(10) Pub. No.: US 2011/0019233 A1
(43) Pub. Date: Jan. 27, 2011

(54) INFORMATION PROCESSING APPARATUS THAT PERFORMS DATA COMMUNICATION USING SIP, METHOD OF CONTROLLING THE SAME, AND STORAGE MEDIUM

(75) Inventor: Yutaka Inoue, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/841,655

(22) Filed: Jul. 22, 2010

(30) Foreign Application Priority Data
Jul. 23, 2009 (JP) 2009-172210

(51) Int. Cl. G06F 3/12

(52) U.S. Cl. 358/1.15

(57) ABSTRACT

An information processing apparatus that inhibits execution of processing for reading data when redirection is inhibited in a transmission mode in which data is not immediately transmitted, thereby being capable of preventing the reading processing from going to waste. When a mode of data transmission is not a direct transmission mode, the apparatus makes a tentative connection. When it is determined from data communication by the tentative connection that a redirect setting has been made by a recipient side, it is determined whether data transmission is permitted. If permitted, image data is read and stored, and then the apparatus makes a reconnection to send the image data stored in the storage section to a redirect destination terminal.

### BACKGROUND OF THE INVENTION

1. Field of the Invention

The present invention relates to an information processing apparatus that performs data communication using SIP (Session Initiation Protocol) as a communication control protocol, and a method of controlling the image forming apparatus.

2. Description of the Related Art

In a case where communication is performed using SIP, a SIP server is provided between a sender-side terminal and a recipient-side terminal, and the sender-side terminal queries the SIP server as to an IP address of the recipient-side terminal to thereby acquire the IP address and request the recipient-side terminal for connection.

Under the above-mentioned communication environment, the recipient-side terminal can make a redirect setting in the SIP server.

The redirect setting is made e.g. when a user on a destination side has to go out and desires receive data addressed to the user not by the user's normal recipient-side terminal, but by a terminal outside the user's house or office when he is out. In this case, the user registers the IP address of the terminal outside the user's house or office as a redirect destination in the SIP server in advance. Thus, when receiving a query from a sender-side terminal, the SIP server notifies the sender-side terminal of the IP address of the terminal of the redirect destination.

However, when data is transferred from a sender-side terminal to a terminal outside a user's house or office, the data can be transmitted to a terminal different from a terminal intended by a sender, and hence there arises a problem from the viewpoint of security.

To solve this problem, there has been proposed a technique in which if a sender-side terminal querying the SIP server is notified that a redirect setting has been made by a recipient side, communication is discontinued (see Japanese Patent Laid-Open Publication No. 2005-94662).

Japanese Patent Laid-Open Publication No. 2005-94662 also discloses a method in which “permitted addresses” are registered for permitting data transmission thereto by way of exception even when a redirect setting has been made by a destination side. In this case, if the data transmission is by direct transmission in which data is immediately transmitted, it is possible to notify the user of the transmission since he/she is supposed to be in front of the apparatus.

However, in the case of memory transmission (including redialing) or time-designated transmission (timer transmission), in which data is once stored in a memory and is then transmitted, the user sometimes leaves the apparatus before the data is actually transmitted. Therefore, there is a fear that it is impossible to notify the user of the redirection of the data.

Further, in the case of the memory transmission or the time-designated transmission, if it is judged before actual transmission that redirection to an address has been set and the address is not among the permitted addresses, the redirection of the data to the address is inhibited, and hence the data stored by reading is not transmitted. Therefore, the processing for reading the data performed in the first place when the transmission was reserved goes to waste.

### SUMMARY OF THE INVENTION

The present invention provides an information processing apparatus that is capable of preventing processing for reading data from going to waste, by inhibiting execution of the processing for reading data in a case where redirection is inhibited in a mode of transmission in which immediate transmission is not performed, a method of controlling the information processing apparatus, and a non-transitory computer-readable storage medium storing a program for causing a computer to execute the method.

In a first aspect of the present invention, there is provided an information processing apparatus that performs data communication using SIP as a communication control protocol, comprising a detection unit adapted to detect whether an immediate transmission mode has been selected by an operation of a user, a tentative connection unit adapted to make a tentative connection when the detection unit detects that the immediate transmission mode has not been selected, a first judgment unit adapted to judge based on data communication made by the tentative connection whether or not a redirect setting has been made by a recipient-side terminal as a destination, a determination unit adapted to determine whether or not data transmission to the redirect destination is permitted, when it is judged by the first judgment unit that the redirect setting has been made, a reading unit adapted to read image data to be transmitted and store the read image data in a storage section, when it is determined by the determination unit that the data transmission to the redirect destination is permitted, a reconnection unit adapted to make a reconnection after processing for reading of the image data by the reading unit, and a transmission unit adapted to transmit the image data stored in the storage section to a terminal of the redirect destination, based on data communication by the reconnection.

In a second aspect of the present invention, there is provided a method of controlling an information processing apparatus that performs data communication using SIP as a communication control protocol, comprising detecting whether an immediate transmission mode has been selected by an operation of a user, making a tentative connection when it is detected by the detecting that the immediate transmission mode has not been selected, judging based on data communication made by the tentative connection whether or not a redirect setting has been made by a recipient-side terminal as a destination, determining whether or not data transmission to the redirect destination is permitted, when it is judged by the judging that the redirect setting has been made, reading image data to be transmitted and storing the read image data in a storage section, when it is determined by the determining that the data transmission to the redirect destination is permitted, making a reconnection after the reading of the image data and transmitting the image data stored in the storage section to a terminal of the redirect destination, based on data communication by the reconnection.

In a third aspect of the present invention, there is provided a non-transitory computer-readable storage unit storing a program for causing a computer to execute method of controlling an information processing apparatus that performs data communication using SIP as a communication control protocol, wherein the method comprises detecting whether an immediate transmission mode has been selected by an operation of a user, making a tentative connection when it is detected by the detecting that the immediate transmission mode has not been selected, judging based on data communication made by the tentative connection whether or not a redirect setting has been made by a recipient-side terminal as a destination, determining whether or not data transmission to the redirect destination is permitted, when it is judged by the judging that the redirect setting has been made, reading image data to be transmitted and storing the read image data in a storage section, when it is determined by the determining that the data transmission to the redirect destination is permitted, making a reconnection after the reading of the image data and transmitting the image data stored in the storage section to a terminal of the redirect destination, based on data communication by the reconnection.

According to the present invention, when redirection is inhibited in a mode of transmission in which immediate transmission is not performed, processing for reading data is inhibited execution, which makes it possible to prevent the reading processing from going to waste.

Further features of the present invention will become apparent from the following description of exemplary embodiments with reference to the attached drawings.

### BRIEF DESCRIPTION OF THE DRAWINGS

FIG. 1 is a schematic diagram of a communication system including an information processing apparatus according to a first embodiment of the present invention.

FIG. 2 is a block diagram of an MFP-X.

FIG. 3 is a sequence diagram useful in explaining processing executed for FAX transmission from the MFP-X to an MFP-A as a transmission destination.

FIG. 4 is a sequence diagram useful in explaining processing executed for FAX transmission from the MFP-X to the MFP-A in a case where an MFP-C is set as a redirect destination for the MFP-A.

FIGS. 5A and 5B are a flowchart of a data transmission process executed by the MFP-X as a sender-side terminal.

FIG. 6 is a diagram of an example of a screen displayed on a display of a display/operation section, for prompting a user for confirmation.

FIGS. 7A and 7B are diagrams useful in explaining an information processing apparatus according to a second embodiment of the present invention, in which FIG. 7A shows a permitted address list of addresses to which redirection of data is permitted, and FIG. 7B shows an inhibited address list of addresses to which redirection of data is inhibited.

FIG. 8 is a flowchart of a data transmission process executed by the MFP-X as a sender-side terminal.

FIG. 9 is a selection screen displayed on a display of a display/operation section of an information processing apparatus according to a third embodiment of the present invention, for prompting a user to select whether or not to make a tentative connection.

FIG. 10 is a flowchart of a data transmission process executed by the MFP-X as a sender-side terminal.

FIG. 11 is a flowchart of a data transmission process executed by the MFP-X as an information processing apparatus according to a fourth embodiment of the present invention.

### DETAILED DESCRIPTION OF THE EMBODIMENTS

The present invention will now be described in detail below with reference to the accompanying drawings showing embodiments thereof.

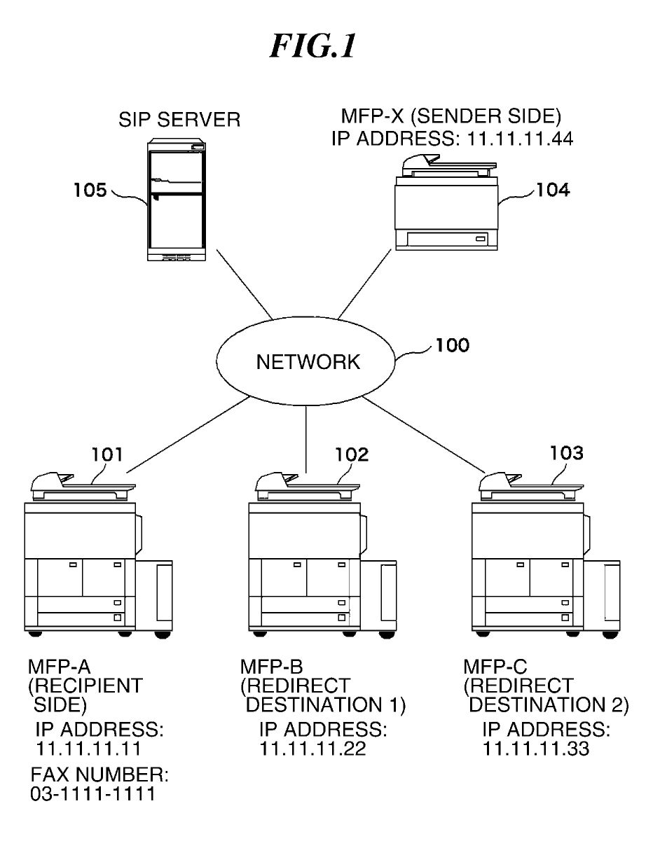

FIG. 1 is a schematic diagram of a communication system including an information processing apparatus according to a first embodiment of the present invention.

In the communication system shown in FIG. 1, an MFP (Multifunction Peripheral)-A 101, an MFP-B 102, an MFP-C 103, an MFP-X 104, and a SIP server 105 each capable of performing data communication using SIP (Session Initiation Protocol) for a communication control protocol are communicably interconnected via a network 100.

The MFP-A 101, the MFP-B 102, the MFP-C 103, and the MFP-X 104 are each equipped with a copy function, a FAX function, and a printing function.

Further, in the illustrated communication system, it is assumed that the MFP-A 101 is a recipient-side terminal, the MFP-B 102 and the MFP-C 103 are redirect destination terminals, and the MFP-X 104 is a sender-side terminal. In the present embodiment, the MFP-X 104 corresponds to an example of the information processing apparatus according to the present invention. The following description is given assuming that the MFP-A 101 is assigned a FAX number “03-1111-1111”.

The SIP server 105 is a combination of a redirect server, a proxy server, a registration server, and a location server, none of which are particularly shown. Further, the SIP server 105 performs the management of registration of each user terminal, user authentication, the conversion of a telephone or FAX number to an IP address, the control of a call control sequence, routing to a connection destination, and so forth.

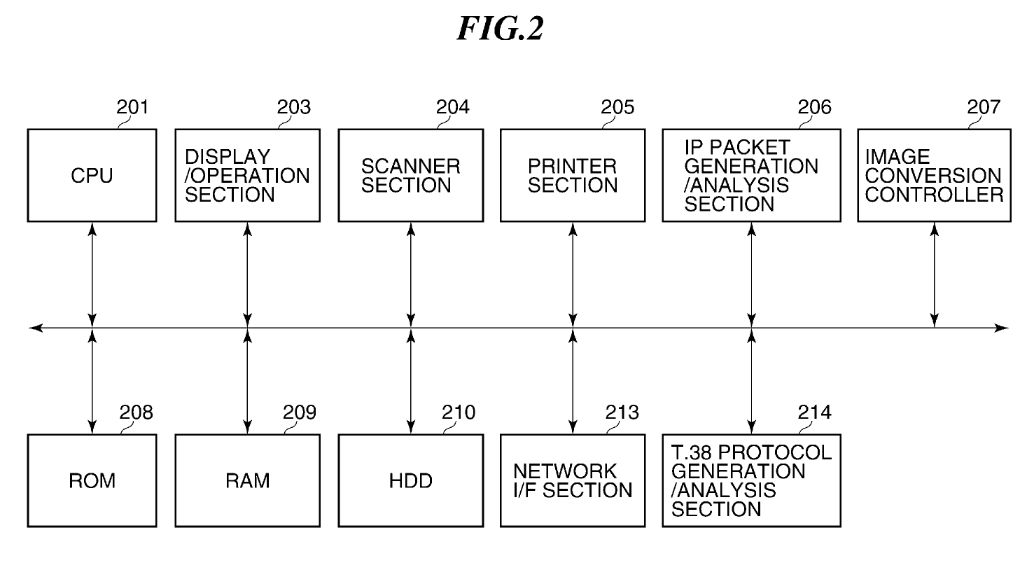

FIG. 2 is a block diagram useful in explaining an example of the configuration of the MFP-X 104. The configurations of the MFP-A 101, the MFP-B 102, and the MFP-C 103 are the same as that of the MFP-X 104, and hence description thereof is omitted.

Referring to FIG. 2, a CPU 201 controls each component device of the MFP-X 104 based on a control program stored in a ROM 208.

A display/operation section 203 includes a display, not shown, and displays e.g. windows, icons, messages, menus, and other user interface information, on a display screen of the display thereof. The display/operation section 203 further includes various kinds of keys, not shown, via which the user performs an operation for copying, FAX transmission and printing, and a screen pointing device, not shown, by which the user operates an icon, a menu, etc. displayed on the display screen.

A scanner section 204 reads an image from an original. A printer section 205 prints out data stored in a RAM (Random Access Memory) 209 or a HDD (Hard Disk Drive) 210. The ROM (Read Only Memory) 208 stores various kinds of control programs and data.

The RAM 209 has a work area for the CPU (Central Processing Unit) 201, a data save area for use in error handling, a load area for loading control programs, and the like. The HDD 210 stores various kinds of control programs and print data.

A network interface (I/F) section 213 is connected to the network 100, and performs communication with the SIP server 105, the MFP-A 101, the MFP-B 102, and the MFP-C 103. The network interface section 213 also performs communication for SIP-FAX.

A T.38 protocol generation/analysis section 214 has the function of generating FAX transmission information that is to be transmitted according to a protocol defined by ITU-T (International Telecommunication Union Telecommunication Standardization Sector) Recommendation T.38, and the function of analyzing received FAX transmission information.

An IP packet generation/analysis section 206 has the function of mapping the protocol defined in ITU-T Recommendation T.38 to IP packets, and further extracting the protocol defined in the ITU-T Recommendation T.38 from received IP packets. An image conversion controller 207 performs the compression, expansion, zooming and linear density conversion of images to be transmitted and received by FAX communication.

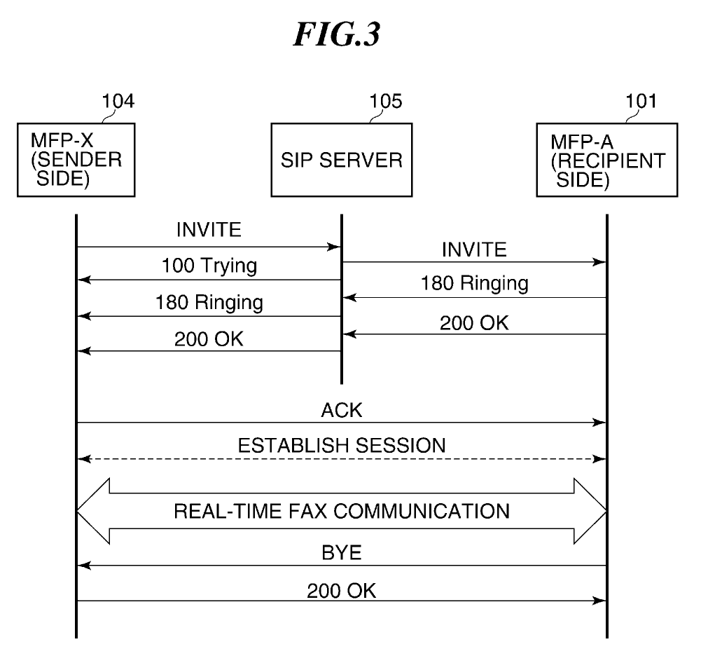

FIG. 3 is a sequence diagram useful in explaining processing executed for FAX transmission from the MFP-X 104 to the FAX number “03-1111-1111” of the MFP-A 101 which is a data transmission destination.

Referring to FIG. 3, first, the MFP-X 104 sends an INVITE request to establish a session with the FAX number “03-1111-1111” of the MFP-A 101 which is the data transmission destination, to the SIP server 105.

The SIP server 105 identifies an IP address “11.11.11.11” of the MFP-A 101 from the FAX number “03-1111-1111” and sends the INVITE request to the MFP-A 101.

Further, the SIP server 105 provisionally sends a 100 Trying Response to the MFP-X 104, thereby notifying the MFP-X 104 that the SIP server 105 is attempting to connect to the MFP-A 101.

Upon receipt of the INVITE request from the SIP server 105, the MFP-A 101 starts a FAX reception process, and returns a 180 Ringing Response, which indicates that a callee is being alerted, to the SIP server 105.

The SIP server 105 routes the above-mentioned 180 Ringing Response returned from the MFP-A 101, thereby transmitting the same to the MFP-X 104.

The MFP-A 101 starts receiving FAX, and sends a 200 OK Response to the MFP-X 104 via the SIP server 105.

Upon receipt of the 200 OK Response, the MFP-X 104 sends ACK acknowledging the receipt of the 200 OK Response to the MFP-A 101.

The reception of ACK by the MFP-A 101 establishes the session between the MFP-X 104 and the MFP-A 101, whereafter real-time FAX communication is performed in compliance with ITU-T Recommendation T.38.

After completing FAX reception, the MFP-A 101 transmits a BYE method to the MFP-X 104. In response to this BYE method, the MFP-X 104 returns the 200 OK Response to the MFP-A 101, followed by terminating the session.

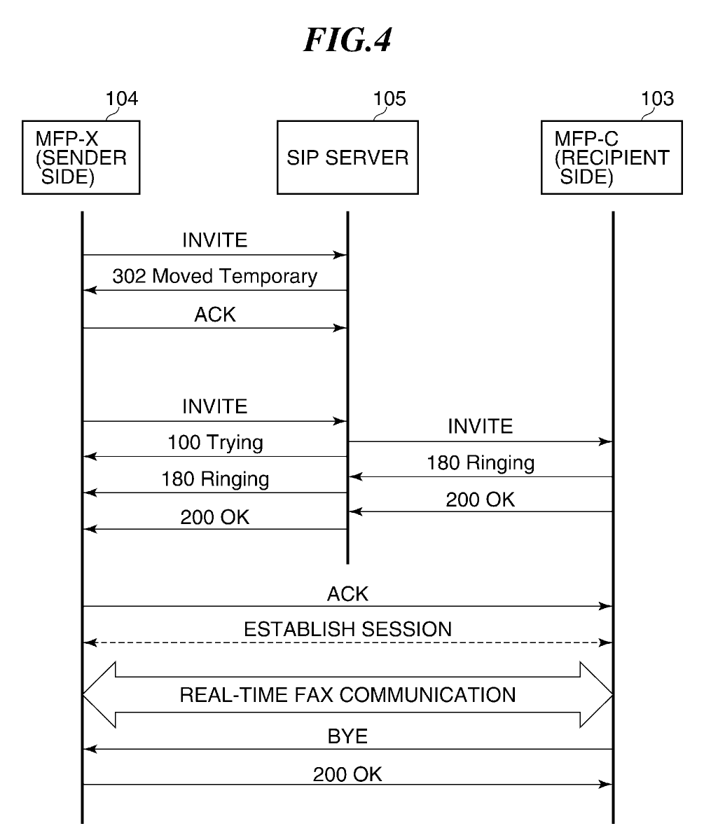

Next, a description will be given of processing executed in a case where FAX transmission is attempted from the MFP-X 104 to the FAX number “03-1111-1111” of the MFP-A 101 for which the MFP-C 103 has been set as a redirect destination, with reference FIG. 4. It should be noted that description of processing executed by the MFP-A 101 for setting a redirect destination in the SIP server 105 is omitted here.

Referring to FIG. 4, first, the MFP-X 104 sends an INVITE request to establish a session with the FAX number “03-1111-1111” of the MFP-A 101 which is a data transmission destination to the SIP server 105.

In response to the INVITE request sent from the MFP-X 104, the SIP server 105 returns a 302 Moved Temporary Response (redirect response) to the MFP-X 104.

In doing this, the SIP server 105 refers to redirect destination setting information stored therein, and returns not only the 302 Moved Temporary Response but also the IP address of the redirect destination terminal set for the FAX number “03-1111-1111” of the MFP-A 101, to the MFP-X 104.

In this case, an IP address “11.11.11.33” of the MFP-C 103 which is set to the redirect destination terminal is returned to the MFP-X 104.

Then, the MFP-X 104 transmits an acknowledgement response “ACK” to the SIP server 105 as a response to the 302 Moved Temporary Response returned from the SIP server 105.

The MFP-X 104 further transmits an INVITE request to the SIP server 105 again. The IP address of a recipient-side terminal this time is the above-mentioned received IP address, i.e. the IP address “11.11.11.33” of the MFP-C 103.

The SIP server 105 routes the INVITE request sent from the MFP-X 104 to thereby send the same to the MFP-C 103, which is the redirect destination. Further, the SIP server 105 provisionally returns a 100 Trying Response to the MFP-X 104, thereby notifying the MFP-X 104 that the SIP server 105 is attempting to connect to the MFP-C 103.

Upon receipt of the INVITE request from the SIP server 105, the MFP-C 103 starts a FAX reception process, and returns a 180 Ringing Response, which indicates that a callee is being alerted, to the SIP server 105.

The SIP server 105 routes the 180 Ringing Response returned from the MFP-C 103 to thereby send the same to the MFP-X 104.

The MFP-C 103 starts receiving FAX, and returns a 200 OK Response to the MFP-X 104 via the SIP server 105.

Upon receipt of the 200 OK Response, the MFP-X 104 sends ACK acknowledging the receipt of the 200 OK Response to the MFP-C 103.

The reception of ACK by the MFP-C 103 establishes the session between the MFP-X 104 and the MFP-C 103, whereafter real-time FAX communication is performed in compliance with ITU-T Recommendation T.38.

After completing FAX reception, the MFP-C 103 transmits a BYE method to the MFP-X 104. In response to this BYE method, the MFP-X 104 sends the 200 OK Response to the MFP-C 103, followed by terminating the session.

Now, a description will be given of an immediate transmission mode and a non-immediate transmission mode of the FAX transmission.

The immediate transmission mode is a mode of data transmission in which a call is connected to (a session is established with) a destination and then while reading data to be transmitted, the read data is transmitted on a real time basis.

In this mode, immediately after the reading of data is terminated, the transmission of the read data is also terminated, and hence the user can confirm whether or not the transmission is normally performed immediately after the termination of the data reading.

On the other hand, the non-intermediate transmission mode includes a memory transmission mode and a timer transmission mode.

In the memory transmission mode, first, data to be transmitted is read and stored in a memory of a FAX machine, and then, after storing all the read data in the memory, a call is made to (a session is established with) the SIP server 105, so as to transmit the stored data.

In this mode, differently from the direct transmission mode, it is difficult to confirm whether or not the data is transmitted to a recipient or destination. However, since all the data is stored, even when the transmission is aborted halfway by an error due to some cause, it is possible to connect again and attempt to transmit the data again, thereby ensuring the data transmission.

The timer transmission mode is a time-designated transmission mode in which data is transmitted by making a call to connect when it becomes a designated time. In this mode as well, data is once read in and stored, similarly to the memory transmission mode, and is only different therefrom in that the data is transmitted at the designated time.

Further, in the memory transmission mode and the timer transmission mode, redialing (making a call again to connect) is executed at a predetermined time interval when a callee i.e. a destination is busy.

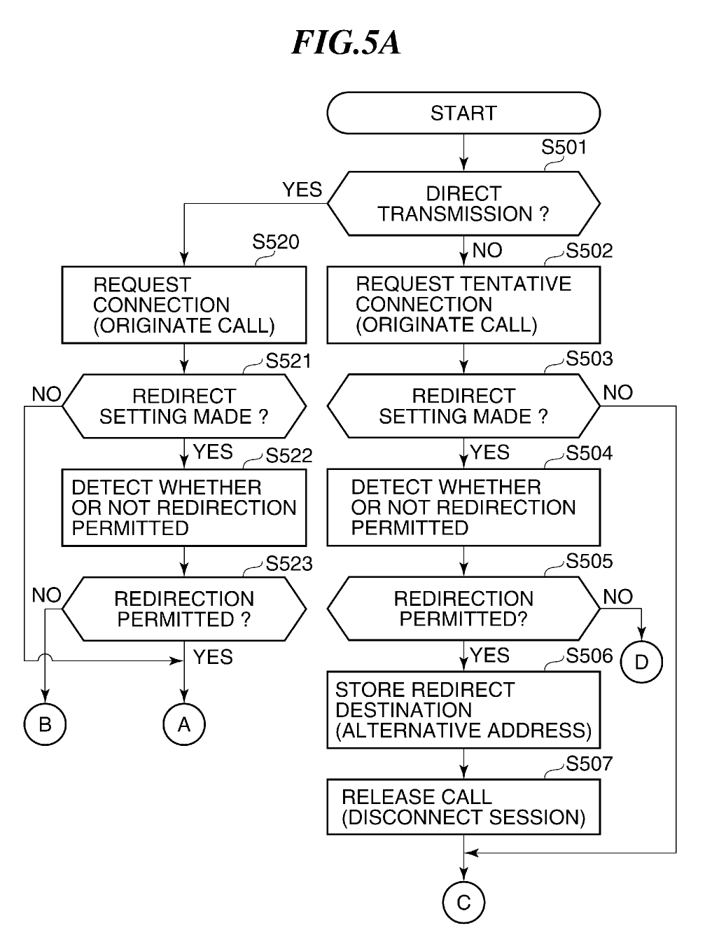

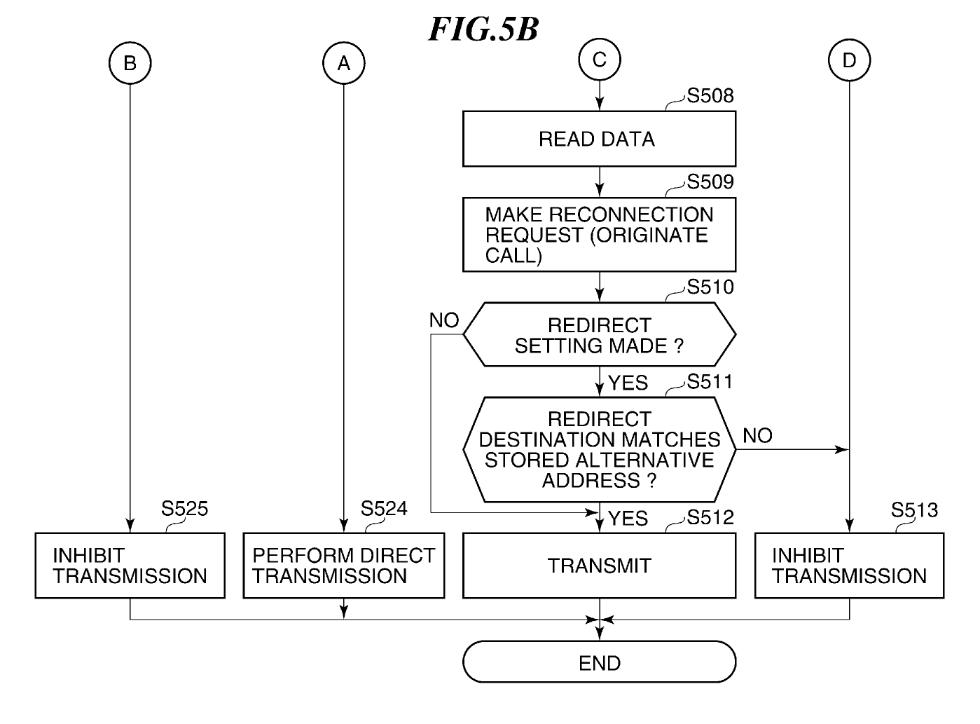

Next, a description will be given of a data transmission process executed by the MFP-X 104 which is a sender-side terminal, with reference to FIGS. 5A and 5B. Processing in each step of the process in FIGS. 5A and 5B is executed e.g. by the CPU 201, by loading a control program stored in a storage unit of the MFP-X 104, such as the ROM 208 or the HDD 210, into the RAM 209.

First, in a step S501, the CPU 201 determines from an operation of the user on the display/operation section 203 whether or not data is to be transmitted in the direct transmission mode which is the immediate transmission mode.

Then, if it is determined that data is to be transmitted in the direct transmission mode, the CPU 201 proceeds a step S520, whereas if not, the CPU 201 proceeds to a step S502.

In the step S520, the CPU 201 transmits an INVITE request (originates a call) for establishment of a session, to the SIP server 105, and then proceeds to a step S521.

In the step S521, the CPU 201 determines, as a first determination as to a redirect setting, whether or not an alternative address (e.g. an IP address) set by the redirect setting is notified from the SIP server 105.

Specifically, if no alternative address is notified by the 302 Moved Temporary Response returned from the SIP server 105, the CPU 201 determines that no redirect setting has been made, and then proceeds to a step S524.

On the other hand, if an alternative address is notified by the 302 Moved Temporary Response returned from the SIP server 105, the CPU 201 determines that the redirect setting has been made, and proceeds to a step S522.

In the step S522, the CPU 201 causes the display/operation section 203 to display a screen on the display thereof, for prompting the user to confirm whether the data may be transmitted to a redirect destination terminal designated in the redirect setting, and then proceeds to a step S523.

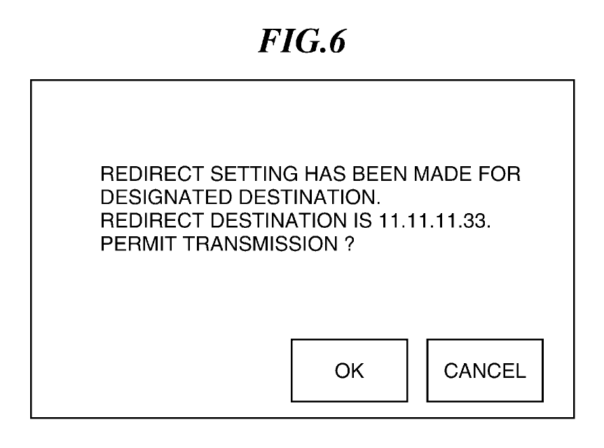

FIG. 6 illustrates an example of the screen displayed on the display of the display/operation section 203, for prompting the user for confirmation.

On the screen illustrated in FIG. 6, the CPU 201 notifies the user, by way of example, that the redirect setting has been made for the designated destination terminal, and displays the address (e.g. the IP address) of a redirect destination, together with an “OK” button and a “Cancel” button for selection as to whether or not to permit redirection of data to this address.

In the step S523, if the “OK” button has been selected on the FIG. 6 screen, the CPU 201 proceeds to a step S524, whereas if the “OK” button has is not operated within a predetermined time period, the CPU 201 proceeds to a step S525.

In the step S524, the CPU 201 performs direct transmission of data, i.e. transmits data while reading the same from the scanner section 204, followed by terminating the present process.

In the step S525, the CPU 201 inhibits processing for direct transmission of data to the redirect destination, followed by terminating the present process.

On the other hand, in the step S502, the CPU 201 transmits an INVITE request (originates a call) which is a request for a tentative connection, to the SIP server, and then proceeds to a step S503.

In the step S503, the CPU 201 determines, as a second determination as to the redirect setting, whether or not an alternative address (e.g. an IP address) set by the redirect setting is notified from the SIP server 105.

Specifically, if no alternative address is notified by the 302 Moved Temporary Response returned from the SIP server 105, the CPU 201 determines that no redirect setting has been made, and then proceeds to a step S508.

On the other hand, if an alternative address is notified by the 302 Moved Temporary Response returned from the SIP server 105, the CPU 201 determines that the redirect setting has been made, and proceeds to a step S504.

In the step S504, the CPU 201 causes the display/operation section 203 to display the FIG. 6 screen for prompting the user to determine whether or not to transmit the data to the redirect destination terminal designated in the redirect setting, and then proceeds to a step S505.

If it is determined in the step S505 that the “OK” button has been selected on the FIG. 6 screen, the CPU 201 proceeds to a step S506, whereas if not, the CPU 201 proceeds to a step S513.

In the step S513, the CPU 202 inhibits data transmission to the redirect destination, followed by terminating the present process.

In the step S506, the CPU 202 temporarily stores the alternative address (IP address) notified by the 302 Moved Temporary Response returned from the SIP server 105, in the storage section, such as the memory or the HDD 210, of the MFP-X 104, and then proceeds to a step S507.

In the step S507, the CPU 202 releases the existing call (session) to once disconnect from the SIP server 105, and then proceeds to a step S508.

In the step S508, the CPU 201 controls the scanner section 204 to read image data to be transmitted and stores the read image data in the storage section, and then proceeds to a step S509.

In the step S509, the CPU 201 sends an INVITE request as a reconnection request for establishment of a session to the SIP server 105, and then proceeds to a step S510.

In the step S510, the CPU 201 determines whether or not an alternative address is notified by a 302 Moved Temporary Response returned from the SIP server 105.

If no alternative address has been notified from the SIP server 105, the CPU 201 determines that no redirect setting has been made, and proceeds to a step S512. On the other hand, if an alternative address has been notified from the SIP server 105, the CPU 201 determines that a redirect setting has been made, and proceeds to a step S511.

In the step S511, the CPU 202 determines whether or not the alternative address notified from the SIP server 105 matches the alternative address temporarily stored in the storage section in the step S506.

Then, if the two alternative addresses match, the CPU 201 proceeds to the step S512, whereas if not, the CPU 201 proceeds to the step S513, wherein the data transmission to the redirect destination is inhibited, followed by terminating the present process.

In the step S512, the CPU 201 transmits the image data stored in the storage section in the step S508, followed by terminating the present process.

Although the above description is made of the memory transmission mode, in the case of the timer transmission mode, a determination step is inserted between the steps S508 and 5509, for determining whether it is time to start the data transmission.

Then, if it is time to start the data transmission, the reconnection request is made in the step S509, and if it is not yet time to start the data transmission, it is waited until it becomes time to start the data transmission.

As described above, in the present embodiment, when data is transmitted in the non-immediate transmission mode other than the direct transmission mode, a request for a tentative connection is made to the SIP server 105 before reading the data by the scanner 204. Then, it is determined whether or not a redirect setting has been made by a recipient side, and if the redirect setting has been made, the processing for reading the data is executed only when the redirection of the data is permitted.

Therefore, if the redirection of the data is inhibited, the processing for reading the data is not executed, which prevents the processing from being unnecessarily executed.

Further, when it is found in the tentative connection that a redirect setting has been made, an address of a redirect destination is temporarily stored, and if it is found in the following reconnection that a redirect setting has been made, the transmission of the data is permitted only when the address of the redirect destination matches the address of the redirect destination temporarily stored.

Therefore, it is possible to prevent data from being transmitted to a destination different from a destination intended by the user on a sender side due to a change in the redirect destination made on a recipient side between the tentative connection and the reconnection. Particularly, in the timer transmission mode, a time period between the tentative connection and the reconnection is set to be long, and hence it is very effective in preventing the data from being transmitted to a destination not intended by a user on a sender side.

Furthermore, when a redirect setting has been made by the recipient side, the user on the sender side is prompted for confirmation as to whether or not to permit data transmission, and only when the user on the sender side permits the data transmission, data is transmitted.

Therefore, even in a case where a redirect setting has been made by a recipient side, if a user on a sender side desires data transmission, data can be transmitted to a redirect destination terminal, which makes it possible to improve user friendliness while maintaining the security function.

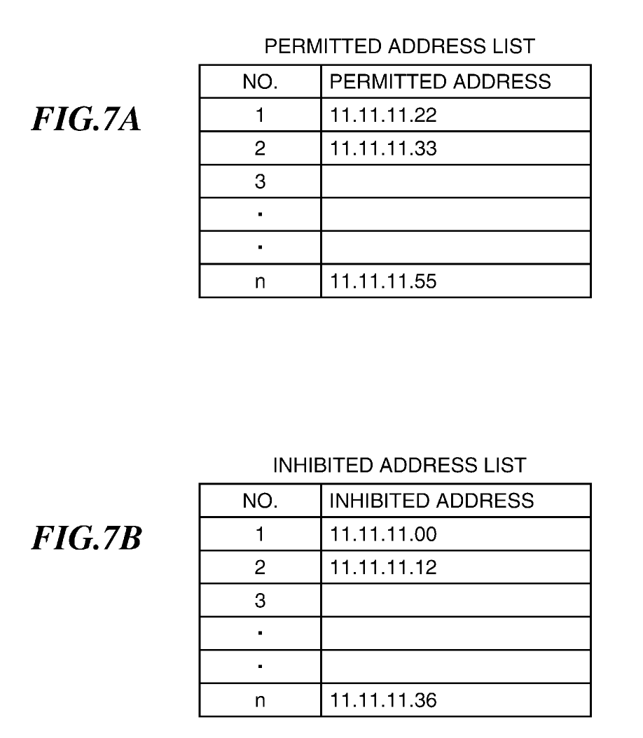

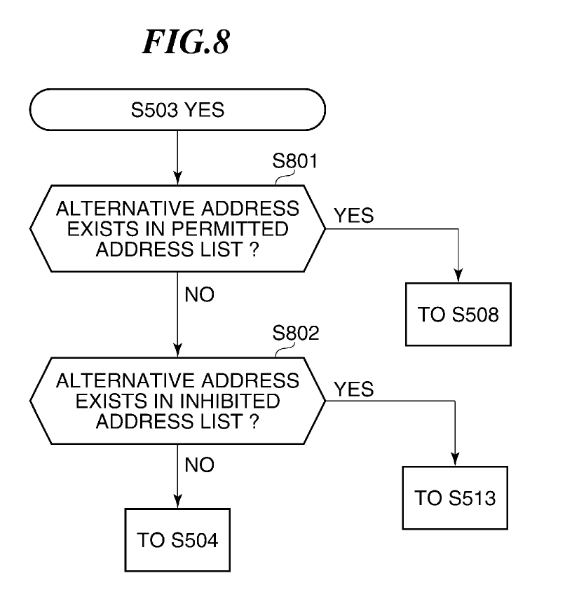

Next, an information processing apparatus according to a second embodiment will be described with reference to FIGS. 7A, 7B, and 8. It should be noted that component parts and elements identical or corresponding to those of the first embodiment will be denoted by identical reference numerals, and description thereof will be given using the figures referred to in describing the first embodiment.

In the present embodiment, there are configured in advance a permitted address list (FIG. 7A) of addresses to which data transmission is permitted and an inhibited address list (FIG. 7B) of addresses to which data transmission is inhibited.

Then, an alternative address notified from the SIP server 105 is checked against the addresses in these lists, thereby controlling processing for prompting a user for confirmation before transmission.

Each of the addresses shown in FIGS. 7A and 7B is the IP address of a redirect destination. A predetermined program refers to transmission history or the like to perform judgment on each of addresses as to whether the user will permit or inhibit data transmission thereto, and based on the judgment, forms the permitted address list and the inhibited address list to store them in a predetermined storage area in advance.

Next, a description will be given of a data transmission process executed by the MFP-X 104 as a sender-side terminal, with reference to FIG. 8. Processing in each step of the process in FIG. 8 is executed e.g. by the CPU 201, by loading a control program stored in the storage unit of the MFP-X 104, such as the ROM 208 or the HDD 210, into the RAM 209.

The present embodiment is described starting from the step S503 in FIG. 5A with reference to which the first embodiment is described, assuming that the answer to the question thereof is affirmative (YES).

First, if an alternative address is notified by the 302 Moved Temporary Response returned from the SIP server 105, the CPU 201 determines in the step S503 that a redirect setting has been made (YES to S503), and proceeds to a step S801.

In the step S801, the CPU 201 checks the alternative address received in the step S503 against the permitted address list shown in FIG. 7A.

If the alternative address exists in the permitted address list, the CPU 201 proceeds to the step S508 in FIG. 5B, wherein the processing for reading the data reading is executed. On the other hand, if the alternative address does not exist in the permitted address list, the CPU 201 proceeds to a step S802.

In the step S802, the CPU 201 checks the alternative address received in the step S503 against the inhibited address list shown in FIG. 7B.

If the alternative address exists in the inhibited address list, the CPU 201 proceeds to the step S513, wherein the CPU 201 executes processing for inhibiting the redirection of data. On the other hand, if the alternative address does not exist in the inhibited address list, the CPU 201 proceeds to the step S504.

In the present embodiment, the permitted address list of addresses to which data transmission is permitted and the inhibited address list of addresses to which data transmission is inhibited are set in advance, and before performing data transmission, the address of a redirect destination is checked against the permitted address list and the inhibited address list, as described above, whereby it is possible to control whether or not to prompt a user for confirmation, and whether to permit or inhibit data transmission to the address of a redirect destination.

This makes it possible to manage addresses of redirect destinations, and dispense with processing for prompting a user for confirmation insofar as addresses existing in the address lists are concerned, which contributes to improvement of user friendliness. The other constructions and advantageous effects of the present embodiment are the same as described hereinabove as to the first embodiment.

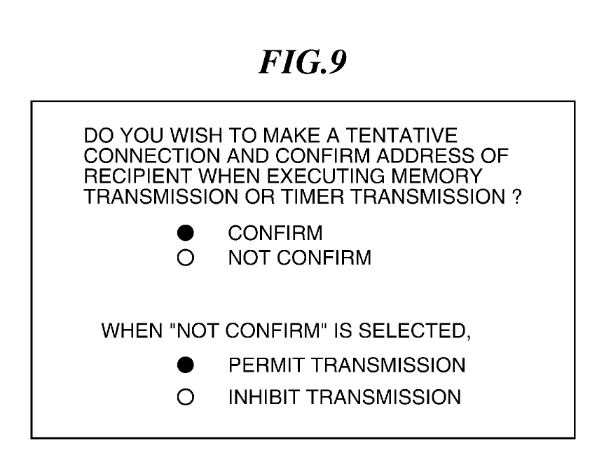

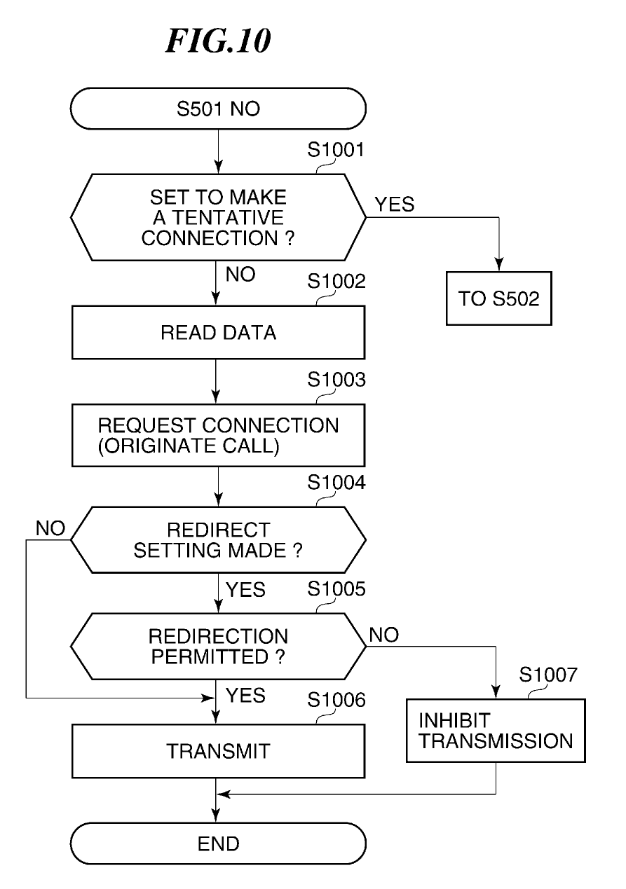

Next, an information processing apparatus according to a third embodiment of the present invention will be described with reference to FIGS. 9 and 10. It should be noted that component parts and elements identical or corresponding to those of the first embodiment will be denoted by identical reference numerals, and description thereof will be given using the figures referred to in describing the first embodiment.

The present embodiment is adapted to a case where when data transmission is to be performed in a mode other than the immediate transmission mode, a user is enabled to select processing for a tentative connection.

FIG. 9 is a selection screen displayed on the display of the display/operation section 203 of an information processing apparatus according to a third embodiment of the present invention, for prompting a user select whether or not to make a tentative connection.

In the case where data transmission is to be performed in a mode other than the direct transmission mode, such as the memory transmission mode or the timer transmission mode, the user is prompted to select on an upper area of the FIG. 9 screen whether or not to make a tentative connection so as to confirm an address of a redirect destination, as a first setting. Further, when the user selects on the upper area of the FIG. 9 screen a setting not to make the tentative connection so as to confirm the address of the redirect destination, the user is also prompted to select on a lower area of the FIG. 9 screen whether to permit or inhibit the data transmission, as a second setting.

Next, a description will be given of a data transmission process executed by the MFP-X 104 which is a sender-side terminal, with reference to FIG. 10. Processing in each step of the process in FIG. 10 is executed e.g. by the CPU 201, by loading a control program stored in the storage unit of the MFP-X 104, such as the ROM 208 or the HDD 210, into the RAM 209.

The present embodiment is described starting from the step S501 in FIG. 5A with reference to which the first embodiment is described, assuming that the answer to the question thereof is negative (NO).

In the step S501, if it is determined from an operation of the user on the display/operation section 203 that data transmission is to be performed in a mode different from the direct transmission mode in which data is immediately transmitted, the CPU 201 proceeds to a step S1001.

In the step S1001, the CPU 201 determines from an operation of the user on the FIG. 9 screen whether a setting has been made to make a tentative connection so as to confirm an address of a redirect destination.

Then, if the setting has been made to make a tentative connection so as to confirm an address of a redirect destination, the CPU 201 proceeds to the step S502 in FIG. 5A, whereas if not, the CPU 201 proceeds to a step S1002.

In the step S1002, the CPU 201 controls the scanner section 204 to cause image data to be transmitted to be read in, and store the read image data for transmission in the storage section, and then proceeds to a step S1003.

In the step S1003, the CPU 201 sends an INVITE request for establishment of a session to the SIP server 105, and then proceeds to a step S1004.

In the step S1004, the CPU 201 determines whether or not an alternative address is notified by a 302 Moved Temporary Response returned from the SIP server 105.

If no alternative address has been notified, the CPU 201 determines that no redirect setting has been made, and proceeds to a step S1006. On the other hand, if an alternative address has been notified, the CPU 201 determines that a redirect setting has been made, and proceeds to a step S1005.

In the step S1005, the CPU 201 determines based on an operation of the user on the FIG. 9 screen whether a setting has been made to permit the data transmission or inhibit the same. If the setting has been made to permit the data transmission, the CPU 201 proceeds to a step S1006, whereas if the setting has been made to inhibit the data transmission, the CPU 201 proceeds to a step S1007.

In the step S1006, the CPU 201 transmits the image data stored in the storage section in the step S1002 to the redirect destination, followed by terminating the present process.

In the step S1007, the CPU 201 inhibits process for the data transmission to the redirect destination, followed by terminating the present process.

As described above, in the present embodiment, when data is to be transmitted in the memory transmission mode or the timer transmission different from a mode for immediate data transmission, processing for a tentative connection can be selected by the user, and hence the freedom of user's configuration of transmission is increased, which contributes to user friendliness. The other constructions and advantageous effects of the present embodiment are the same as described hereinabove as to the first embodiment.

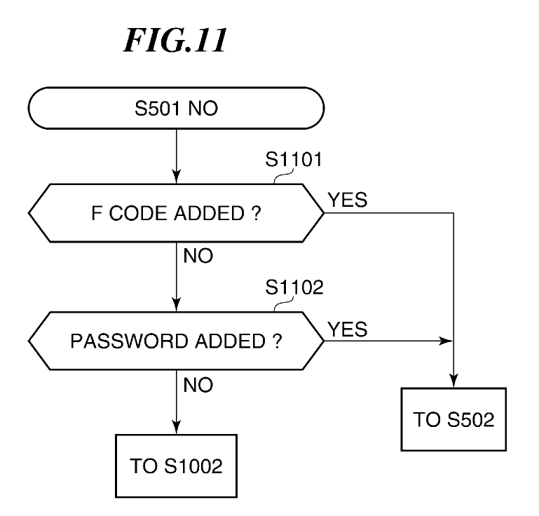

Next, an information processing apparatus according to a fourth embodiment of the present invention will be described with reference to FIG. 11. It should be noted that component parts and elements identical or corresponding to those of the first and third embodiments will be denoted by identical reference numerals, and description thereof will be given using the figures referred to in describing the first and third embodiments.

In the present embodiment, processing shown in FIG. 10 concerning whether or not to make the tentative connection is switchingly controlled depending on the degree of confidentiality of data to be transmitted. In general, as the FAX transmission mode, there is not only a normal FAX transmission mode but also a confidential transmission mode in which data is transmitted after identifying a recipient user who receives data, in advance.

In the confidential transmission mode, a recipient receives data, for example, not in a printed form, but in a state stored in a memory or a so-called box for use in confidential reception.

Identification information, such as a password, is set in advance for the memory or the box, so as to prevent the data stored in the memory or the box from being read when the identification information cannot be identified.

In data transmission in the confidential transmission mode, an F code or a password defined by ITU-TT.30 as a standard of FAX communication protocol is used, and the F code or the password set in advance based on the FAX protocol data is transmitted before execution of FAX data transmission. The method of setting the F code or the password for confidential transmission is a known method, and therefore description thereof is omitted.

Next, a description will be given of a data transmission process executed by the MFP-X 104 which is a sender-side terminal, with reference to FIG. 11. Processing in each step of the process in FIG. 11 is executed e.g. by the CPU 201, by loading a control program stored in the storage unit of the MFP-X 104, such as the ROM 208 or the HDD 210, into the RAM 209.

The present embodiment is described starting from the step S501 in FIG. 5A with reference to which the first embodiment is described, assuming that the answer to the question thereof is negative (YES).

If it is determined in the step S501 from an operation of the user on the display/operation section 203 that data transmission is to be performed in a mode different from the direct transmission mode in which data is immediately transmitted, the CPU 201 proceeds to a step S1101.

In the step S1101, the CPU 201 determines whether or not data having an F code added thereto is to be transmitted.

If data having an F code added thereto is to be transmitted, the CPU 201 proceeds to the step S502 in FIG. 5A, wherein the CPU 201 executes processing for a tentative connection. On the other hand, if data without an F code is to be transmitted, the CPU 201 proceeds to the step S1102.

In the step S1102, the CPU 201 determines whether or not data having a password added thereto is to be transmitted.

Then, if the data to be transmitted is data having a password added thereto, the CPU 201 proceeds to the step S502 in FIG. 5A to make a request for the tentative connection, whereas if the data to be transmitted is not data having a password added thereto, the CPU 201 proceeds to the step S1002 in FIG. 10 to perform processing for reading image data to be transmitted. In this case, in the step S1005, only the lower part of the FIG. 9 screen is displayed on the display of the display/operation section 203.

As described above, in the present embodiment, when transmitting data having a high degree of confidentiality, such as F code-added data or password-added data, it is possible to make sure of a recipient of a direct destination by making a tentative connection. This makes it possible to prevent the data from being transmitted to a recipient different from an intended person. The other constructions and advantageous effects of the present embodiment are the same as described hereinabove as to the first and embodiments.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-172210, filed Jul. 23, 2009, which is hereby incorporated by reference herein in its entirety.

What is claimed is:

1. An information processing apparatus that performs data communication using SIP as a communication control protocol, comprising:
a detection unit adapted to detect whether an immediate transmission mode has been selected by an operation of a user;
a tentative connection unit adapted to make a tentative connection when said detection unit detects that the immediate transmission mode has not been selected;
a first judgment unit adapted to judge based on data communication made by the tentative connection whether or not a redirect setting has been made by a recipient-side terminal as a destination;
a determination unit adapted to determine whether or not data transmission to the redirect destination is permitted, when it is judged by said first judgment unit that the redirect setting has been made;
a reading unit adapted to read image data to be transmitted and store the read image data in a storage section, when it is determined by said determination unit that the data transmission to the redirect destination is permitted;
a reconnection unit adapted to make a reconnection after processing for reading of the image data by said reading unit; and
a transmission unit adapted to transmit the image data stored in the storage section to a terminal of the redirect destination, based on data communication by the reconnection.

2. The information processing apparatus according to claim 1, further comprising:
a second judgment unit adapted to judge based on the data communication by the reconnection by said reconnection unit whether or not a redirect setting has been made by the recipient-side terminal as the destination; and
a control unit adapted to permit the transmission of the image data stored in the storage unit to the terminal of the redirect destination when it is determined by said second judgment unit that the redirect setting has been made.

3. The information processing apparatus according to claim 2, wherein said control unit permits the transmission of the image data stored in the storage unit to the terminal of the redirect destination when it is determined by said second judgment unit that the redirect setting has been made, only on condition that the redirect destination matches the redirect destination the data transmission to which said determination unit determines to be permitted.

4. The information processing apparatus according to claim 1, further comprising a confirmation unit adapted to prompt the user to confirm whether or not permit the data transmission to a terminal of the redirect destination when it is judged by said first judgment unit that the redirect setting has been made, and
wherein when it is confirmed via said confirmation unit that the data transmission to the terminal of the redirect destination is permitted, said determination unit determines that the data transmission to the redirect destination is permitted.

5. The information processing apparatus according to claim 1, further comprising:
a storage unit adapted to store a permitted address list of destination addresses to which redirection is permitted, and a inhibited address list of destination addresses to which redirection is inhibited; and
a check unit adapted to check the address of the redirect destination against the permitted address list and the inhibited address list which are stored in said storage unit,
wherein when checking by said check unit shows that the address of the redirect destination exists in the permitted address list, said determination unit determines that the data transmission to the redirect destination is permitted, and when the checking by said check unit shows that the address of the redirect destination exists in the inhibited address list, said determination unit determines that the data transmission to the redirect destination is not permitted.

6. The information processing apparatus according to claim 1, further comprising:
a first setting unit adapted to set whether or not to cause said tentative connection unit to make the tentative connection;
a second setting unit adapted to be operable when said first setting unit sets not to cause said tentative connection unit to make the tentative connection, to set whether or not to permit the data transmission to the terminal of the redirect destination.

7. The information processing apparatus according to claim 6, wherein said first setting unit sets not to cause said tentative connection unit to make the tentative connection, when data to be transmitted has identification information added thereto.

8. A method of controlling an information processing apparatus that performs data communication using SIP as a communication control protocol, comprising:
detecting whether an immediate transmission mode has been selected by an operation of a user;
making a tentative connection when it is detected by said detecting that the immediate transmission mode has not been selected;
judging based on data communication made by the tentative connection whether or not a redirect setting has been made by a recipient-side terminal as a destination;
determining whether or not data transmission to the redirect destination is permitted, when it judged by said judging that the redirect setting has been made;
reading image data to be transmitted and storing the read image data in a storage section, when it is determined by said determining that the data transmission to the redirect destination is permitted;
making a reconnection after said reading of the image data; and
transmitting the image data stored in the storage section to a terminal of the redirect destination, based on data communication by the reconnection.

9. A non-transitory computer-readable storage unit storing a program for causing a computer to execute method of controlling an information processing apparatus that performs data communication using SIP as a communication control protocol,
wherein the method comprises:
detecting whether an immediate transmission mode has been selected by an operation of a user;
making a tentative connection when it is detected by said detecting that the immediate transmission mode has not been selected;
judging based on data communication made by the tentative connection whether or not a redirect setting has been made by a recipient-side terminal as a destination;
determining whether or not data transmission to the redirect destination is permitted, when it judged by said judging that the redirect setting has been made;
reading image data to be transmitted and storing the read image data in a storage section, when it is determined by said determining that the data transmission to the redirect destination is permitted;
making a reconnection after said reading of the image data; and
transmitting the image data stored in the storage section to a terminal of the redirect destination, based on data communication by the reconnection.
